(19) United States
(12) Patent Application Publication
(10) Pub. No.: US 2026/0186948 A1
(43) Pub. Date: Jul. 2, 2026

(54) IDENTIFYING SOFTWARE REGRESSIONS IN A PRODUCTION CLOUD ENVIRONMENT

(71) Applicant: Oracle International Corporation, Redwood Shores, CA (US)

(72) Inventors: Yu Li, Foster City, CA (US); Prateek Somani, Bhilwara (IN); Paul Hsu, San Diego, CA (US)

(73) Assignee: Oracle International Corporation, Redwood Shores, CA (US)

(21) Appl. No.: 19/005,186

(22) Filed: Dec. 30, 2024

(51) Int. Cl. G06F 11/3604; G06F 8/65

(52) U.S. Cl. CPC G06F 11/3612; G06F 8/65

(57) ABSTRACT

Disclosed is an approach to proactively identify software regressions in production cloud environments with saved copies of actual customer workloads. By running real customer workloads, regressions can be detected and the cause of the culprits identified to help facilitate resolution.

### BACKGROUND

Modern software systems are complex, often composed of numerous modules, components, and integrations that need to work seamlessly to provide intended functionality. As these systems grow and evolve, they undergo continuous updates, modifications, and refinements to add new features, optimize performance, or fix bugs. However, such changes may inadvertently introduce regressions—unexpected behavior, performance issues, or failures in existing functionalities that previously operated as intended. Identifying and addressing these regressions quickly and effectively is essential to maintain the quality, stability, and reliability of the software.

Conventional methods for identifying regressions typically rely on extensive manual testing, automated test suites, or both. However, manual testing is time-consuming, resource-intensive, and prone to human error. While automated testing frameworks can improve efficiency, they often struggle to adapt to complex changes in the codebase or to keep up with the fast-paced deployment cycles in modern software development. Furthermore, existing automated tests might not cover all potential regressions, especially in highly integrated and dynamic systems.

Traditional testing tools also face limitations in distinguishing between changes that introduce regressions and intentional code changes that reflect desired improvements. This gap in current methods often leads to a high rate of false positives in identifying potential regressions, causing developers to spend significant time analyzing issues that do not affect system functionality.

These problems are further amplified in a cloud computing environment. Cloud-based applications typically comprise multiple services, virtual machines, containers, and databases that interact across a networked infrastructure. This complexity is further heightened by the rapid, iterative development and deployment cycles common in cloud environments, where continuous integration and delivery (CI/CD) practices enable frequent updates to code and configurations. However, each update or modification to cloud applications has the potential to introduce regressions, and the challenge of identifying regressions is compounded by the distributed and ephemeral nature of cloud resources. Unlike traditional on-premises systems, cloud-based services often rely on dynamic resource allocation, auto-scaling, and multi-tenant architectures, which can lead to variable behavior across deployments. Moreover, cloud environments may undergo infrastructure updates or changes in third-party dependencies that are outside the control of the application developer. This dynamic nature makes it difficult for traditional testing and monitoring methods to effectively capture and diagnose regressions, especially when issues manifest only under certain load conditions, specific configurations, or isolated cloud regions.

Therefore, there is a need for an improved approach to implement a solution that addresses the issues identified above.

### SUMMARY

Some embodiments of the invention provide an approach to proactively identify software regressions in production cloud environments with saved copies of actual customer workloads. By running real customer workloads, regressions can be detected and the cause of the regressions identified to help facilitate resolution.

Further details of aspects, objects, and advantages of the invention are described below in the detailed description, drawings, and claims. Both the foregoing general description and the following detailed description are exemplary and explanatory, and are not intended to be limiting as to the scope of the invention.

### BRIEF DESCRIPTION OF THE FIGURES

The drawings illustrate the design and utility of some embodiments of the present invention. It should be noted that the figures are not drawn to scale and that elements of similar structures or functions are represented by like reference numerals throughout the figures. In order to better appreciate how to obtain the above-recited and other advantages and objects of various embodiments of the invention, a more detailed description of the present inventions briefly described above will be rendered by reference to specific embodiments thereof, which are illustrated in the accompanying drawings. Understanding that these drawings depict only typical embodiments of the invention and are not therefore to be considered limiting of its scope, the invention will be described and explained with additional specificity and detail through the use of the accompanying drawings in which:

FIG. 1 provides a high-level illustration of an architecture to detect regressions according to some embodiments of the invention.

FIG. 2 shows a high-level flowchart for operation of some embodiments of the invention.

FIG. 3 shows a more detailed architecture for detecting regressions according to some embodiments of the invention.

FIG. 4 shows a flowchart of a sequence of steps to be applied in the architecture of FIG. 3.

FIG. 5 is a block diagram of an illustrative computing system suitable for implementing an embodiment of the present invention.

FIG. 6 is a block diagram of one or more components of a system environment in which services may be offered as cloud services, in accordance with an embodiment of the present invention.

### DETAILED DESCRIPTION OF THE EMBODIMENTS OF THE INVENTION

Various embodiments are described hereinafter with reference to the figures. It should be noted that the figures are not necessarily drawn to scale. It should also be noted that the figures are only intended to facilitate the description of the embodiments, and are not intended as an exhaustive description of the invention or as a limitation on the scope of the invention. In addition, an illustrated embodiment need not have all the aspects or advantages shown. An aspect or an advantage described in conjunction with a particular embodiment is not necessarily limited to that embodiment and can be practiced in any other embodiments even if not so illustrated. Also, reference throughout this specification to “some embodiments” or “other embodiments” means that a particular feature, structure, material, or characteristic described in connection with the embodiments is included in at least one embodiment. Thus, the appearances of the phrase “in some embodiments” or “in other embodiments,” in various places throughout this specification are not necessarily referring to the same embodiment or embodiments.

In a cloud computing environment, computing systems may be provided as a service to customers. One of the main reasons for the rising popularity of cloud computing is that the cloud computing model typically allows customers to avoid or minimize both the upfront costs and ongoing costs that are associated with maintenance of IT infrastructures. Moreover, the cloud computing paradigm permits high levels of flexibility for the customer with regards to its usage and consumption requirements for computing resources, since the customer only pays for the resources that it actually needs rather than investing in a massive data center infrastructure that may or may not actually be efficiently utilized at any given period of time.

The cloud resources may be used for any type of purpose or applicable usage configuration by a customer. For example, the cloud provider might host a large number of virtualized processing entities on behalf of the customer in the cloud infrastructure. The cloud provider may provide devices from within its own infrastructure location that are utilized by the cloud customers. In addition, the cloud provider may provide various services (e.g., database services) to customers from the cloud. As yet another example, the cloud provider may provide the underlying hardware device to the customer (e.g., where the device is located within the customer's own data center), but handle implementation and administration of the device as part of the cloud provider's cloud environment.

One of the main functions performed by the cloud provider in the cloud computing model is the administration and maintenance of the cloud computing resources. By having the administrative staff of the cloud provider take control over these administrative tasks, this minimizes the need and costs for the customer to maintain its own IT staffing and infrastructure to handle these tasks, which is in essence one of the main advantages of the cloud computing paradigm for customers. To perform these tasks, the typical scenario is for the cloud provider's administrative staff to have the ability to access and perform administrative functions within the cloud resources.

A common administrative task performed by cloud administrators is to introduce updates or patches to the software maintained in the cloud by the cloud operators. In some cloud environments, patching may occur fairly frequently, e.g., every 1-2 weeks. Each patch may include many hundreds of changes to the software. These updates or patches are often needed to add new features, optimize performance, or fix bugs in the production software. However, as previously noted, modern software systems are very complex, and may be composed of numerous modules, components, and integrations, and it is possible that changes made by an administrator via the update or patch may inadvertently introduce regressions. Indeed, with hundreds of changes potentially introduced within even a single patch, it is quite likely that a regression will inevitably occur.

Because the cloud customers are reliant upon the proper functioning of the cloud system in order to have their work performed, it is critical to be able to proactively detect the regression. It is also very important to make sure that the regression is detected very early, and with the proper identification of the “culprit transaction” of the regression. The culprit transaction refers to the specific change (transaction) that results in the regression. Early identification of the culprit transaction is important in order to expedite resolution of the regression.

A database “transaction” is a series of operations performed on a database that is treated as a single unit of work. In a typical database system, either all operations within the transaction are completed successfully, or none of them are, ensuring the database remains in a consistent state even if errors occur. While the term “culprit transaction” may be employed in this disclosure, it is noted that the inventive concept as described herein may be used to identify any granularity of a “culprit” that causes a regression, whether that culprit is a transaction or some other entity or unit of measure that can be identifiable as a cause for a regression, and thus the invention is not limited to a culprit “transaction” unless expressly claimed as such.

Some embodiments of the invention provide an approach to proactively identify software regressions in production cloud environments with saved copies of actual customer workloads. By running real customer workloads, regressions can be detected and the cause of the regressions identified to help facilitate resolution.

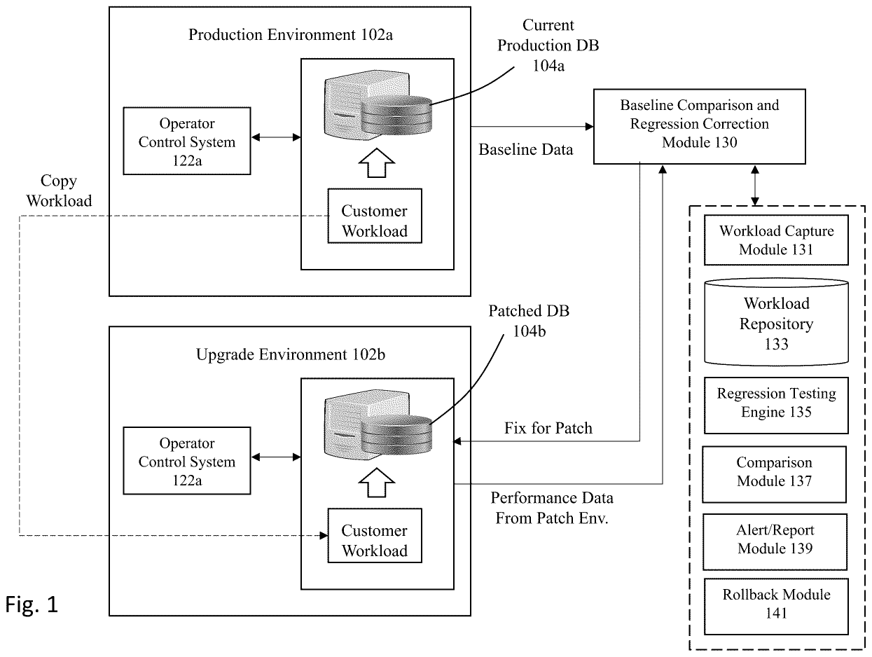

FIG. 1 provides a high-level illustration of an architecture to detect regressions according to some embodiments of the invention. The present invention provides a system and method for identifying and addressing regressions in cloud-based computing environments by utilizing past customer workloads to conduct high-fidelity testing of new code and configuration changes. By retaining and replaying historical customer workloads, the system can accurately simulate real-world scenarios, allowing for more precise detection of potential regressions, including functional errors, performance degradation, and compatibility issues.

This figure shows a cloud computing system that includes one or more cloud infrastructure resources within a production cloud environment 102a that are used by one or more cloud customers. The cloud infrastructure resources correspond to any type of infrastructure resource that may be allocated and used within a cloud computing environment. In some embodiments, the resources may include a shared binary approach, in which each of multiple different customers are associated with different respective “/home” directories for their software, but where the software binaries themselves are actually shared between the different customers within a shared home. For a database cloud provider, having a shared home can be used to maximize the number of database instances that can be published to the customers. A current production database 104a may be running within the shared home directory in the production environment 102a.

In this cloud deployment model, the customer may be responsible for the application/user-space level activities on the device, e.g., the operation and implementation of virtual machines, and/or the management of database management software that reside on machine. These are used by the customer to implement customer workloads.

However, the cloud provider is responsible for management of the infrastructure components for that device (e.g., chassis power, bare metal operating system, hypervisors, storage services, networking services, etc.) using an operator control system 122a. Any updates or patching is performed by cloud operators via the operator control system 122a.

In particular, the updates or patches may be applied to software that is situated in an upgrade environment 102b. The upgrade environment 102b will include a patched version of the DB software 104b.

This architecture may include a baseline comparison and regression correction module 130. In operation, this module 130 operates by storing actual customer workloads, along with baseline data regarding the performance of those customer workloads. When the production software is patched, that same customer workload is then executed through the patched version of the software, and performance data collected for the workload execution. A comparison can be performed between the baseline performance data and the performance data for execution using the patched software, with any errors identified through these comparisons.

The baseline comparison and regression correction module 130 may include numerous sub-modules proactively identifying software regressions.

The system may include a workload capture module 131. This module captures and logs customer workloads within the cloud environment. Workloads may include application requests, user interactions, transaction data, network configurations, and infrastructure settings. These captured workloads are stored in a secure data repository, allowing the system to accurately retain the parameters, sequence, and frequency of real customer usage.

In one embodiment, the workload capture module comprises an interface for the user to save its workload. The user may choose a specific workload, or indeed, may save any number of workloads it seems important or to be representative of its overall work composition.

In another embodiment, the workload capture module may operate to automatically capture the customer workloads. For example, the system may use the “Database Replay” feature that is available in databases provided by Oracle Corporation of Redwood Shores, California. The database replay feature can be used to capture a workload on the production system and replay it on a test system with the exact timing, concurrency, and transaction characteristics of the original workload. This enables the system to test the effects of a system change without affecting the production system. The first step in using Database Replay is to capture the production workload. Capturing a workload involves recording all requests made by external clients to the database.

The system may also include a workload repository 133, which is a storage system that maintains a history of past customer workloads. The repository includes a time-stamped log of workloads that reflects actual usage patterns, application states, configuration parameters, and environmental variables (e.g., network latency, load conditions, geographic distribution). The repository is structured to allow filtering, categorization, and retrieval of workloads based on factors such as customer ID, application version, workload type, and performance thresholds.

For example, when workload capture is enabled using database replay, all external client requests directed to the database are tracked and stored in binary files—called capture files—on the file system. The user can specify the location where the capture files will be stored. Once workload capture begins, all external database calls are written to the capture files. The capture files contain all relevant information about the client request, such as SQL text, bind values, and transaction information. These capture files are platform independent and can be transported to another system.

Once the workload has been captured, the information in the capture files can be preprocessed. Preprocessing creates all necessary metadata needed for replaying the workload. This should be done once for every captured workload before they can be replayed. After the captured workload is preprocessed, it can be replayed repeatedly on a replay system running the same version of the database.

The system may include a regression testing engine 135, which replays selected historical workloads against new application versions, infrastructure changes, or configuration updates within the test environment. The engine dynamically adjusts workload parameters to simulate different conditions (e.g., peak traffic, varying latencies) while preserving the integrity of the workload sequences to accurately mirror real-world usage patterns.

During the workload replay phase, the database performs the actions recorded during the workload capture phase on the test system by re-creating all captured external client requests with the same timing, concurrency, and transaction dependencies of the production system. Database Replay uses a client program to re-create all external client requests recorded during workload capture. Depending on the captured workload, one may need one or more replay clients to properly replay the workload. A calibration tool can be used to help determine the number of replay clients needed for a particular workload. Because the entire workload is replayed—including DML and SQL queries—the data in the replay system should be as logically similar to the data in the capture system as possible. This will minimize replay divergence and enable a more reliable analysis of the replay.

The system may include a comparison and analysis module 137, which compares the outputs, response times, and system behaviors resulting from the replayed workloads with historical baselines captured during previous deployments. The comparison process identifies discrepancies, such as errors, delays, or unexpected responses, that indicate potential regressions. Key metrics used for analysis include functional correctness, API response times, and resources consumed such as memory utilization, disk storage, average load CPU utilization, network operations, and disk operations.

An alerting and reporting module 139 may also be implemented in the system. When a regression is detected, the alerting module generates notifications to inform relevant development, quality assurance, and operations teams. Detailed reports provide actionable insights into the nature and extent of the regression, including specific workload parameters that triggered the issue, performance deviations, and links to the relevant code or configuration changes.

The workload capture report and workload replay report provide basic information about the workload capture and replay, such as errors encountered during replay and data divergence in rows returned by DML or SQL queries. A comparison of several statistics—such as database time, average active sessions, and user calls—between the workload capture and the workload replay is also provided.

The replay compare period report can be used to perform a high-level comparison of one workload replay to its capture or to another replay of the same capture. A divergence summary with an analysis of whether any data divergence occurred and if there were any significant performance changes is also provided.

For advanced analysis, Automatic Workload Repository (AWR) reports are available to enable detailed comparison of performance statistics between the workload capture and the workload replay. The information available in these reports is very detailed, and some differences between the workload capture and replay can be expected. Furthermore, workload intelligence analysis can operate on data recorded during a workload capture to create a model that describes the workload. This model can be used to identify significant patterns in templates that are executed as part of the workload. For each pattern, one can view important statistics, such as the number of executions of a given pattern and the database time consumed by the pattern during its execution.

A SQL performance analyzer report can be used to compare a SQL tuning set from a workload capture to another SQL tuning set from a workload replay, or two SQL tuning sets from two workload replays. Comparing SQL tuning sets with Database Replay provides more information than just a SQL performance analyzer test-execute because it considers and shows all execution plans for each SQL statement, while a SQL performance analyzer test-execute generates only one execution plan per SQL statement for each SQL trial. Moreover, the SQL statements are executed in a more authentic environment because Database Replay captures all bind values and reproduces dynamic session state such as PL/SQL package state more accurately.

Besides using replay divergence information to analyze replay characteristics of a given system change, an application-level validation procedure can be used to assess the system change.

A remediation and rollback module 141 may be included in the system. To minimize downtime and prevent degraded performance for customers, the system includes a remediation module that can roll back problematic changes or apply fixes when critical regressions are detected. In cases where manual intervention is necessary, the system provides developers with detailed diagnostic information to expedite resolution. Automated processing of rollbacks and fixes may also be implemented, e.g., using a rulebase or a library of patch corrections.

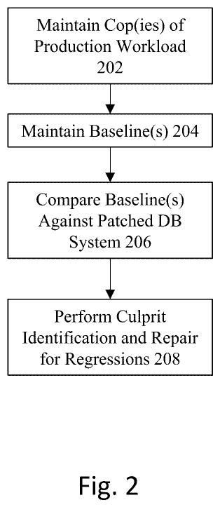

FIG. 2 shows a high-level flowchart for operation of some embodiments of the invention.

At 202, one or more copies of production workloads are maintained. As noted above, the capture of the customer workload may be performed manually or automatically. Any number of customer workloads may be maintained within the system.

At 204, one or more baselines are maintained for the customer workloads. When a customer interacts with a cloud-based application, the system's workload capture module logs relevant details about the request, response, and infrastructure context. For instance, the system may record HTTP requests, database queries, response payloads, latency, CPU and memory usage, and the specific cloud resources utilized during each interaction. This information is then securely stored in the workload repository and categorized by workload type, application version, customer ID, and other metadata, making it easily retrievable for future testing.

At 206, the customer workloads are executed within a patched environment, and the results are compared against the baseline results. When a new update (e.g., code changes, infrastructure modification, or configuration adjustment) is ready for deployment, the regression testing engine retrieves a set of historical workloads from the repository to serve as test cases. Workload selection criteria are based on the characteristics of the update, aiming to include workloads that are representative of the customer base or are known to be sensitive to specific changes. The system can simulate these workloads under various conditions, such as peak load, minimal resources, or increased network latency, to observe how the update performs across diverse scenarios.

A regression testing engine replays these selected workloads within the test environment that mirrors the production cloud infrastructure. During this phase, the system preserves the sequence and timing of the original workloads to ensure that interactions and dependencies are reproduced with high fidelity.

At 208, regression detection and analysis are performed to identify any culprit transactions. This step monitors and records the application's responses, performance metrics, and system behaviors as the workloads are replayed. Analysis is performed to compare these outputs against baseline data from previous deployments, which serves as a reference for expected behavior. This comparison helps detect a wide range of regression types, such as for example: (a) Functional Regressions: Discrepancies in functional output, such as incorrect data in responses, missing fields, or broken links, signal a potential functional regression; (b) Performance Regressions: By comparing response times, resource utilization, and load handling capacity to historical metrics, the system can identify performance degradations, e.g., increased latency or higher CPU usage under the same workload indicates a performance regression; (c) Infrastructure Regressions: Changes to cloud infrastructure components, such as updates to virtual machines, networking configurations, or third-party services, may introduce incompatibilities; the system can detect and isolate these issues by analyzing discrepancies in behaviors triggered by specific infrastructure-dependent workloads.

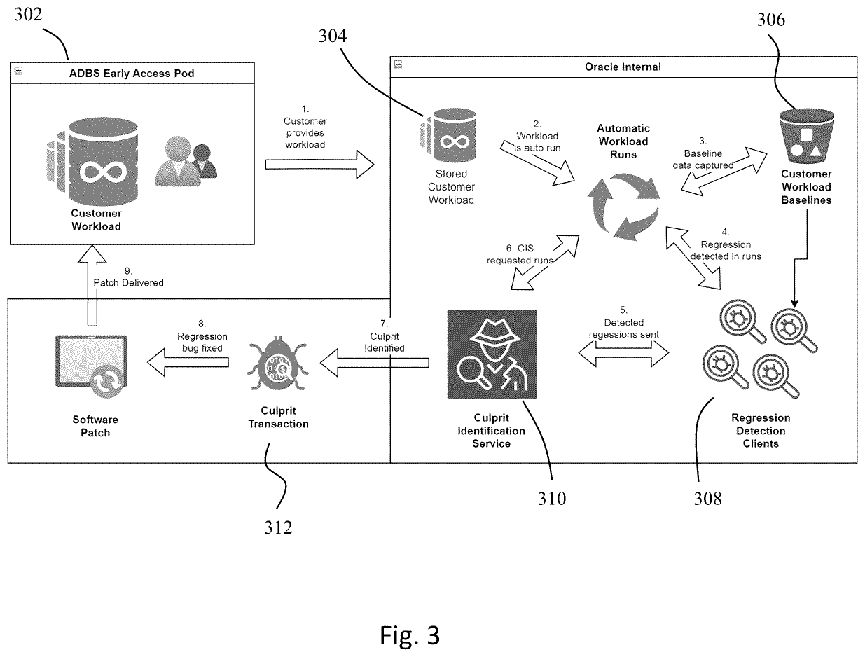

FIG. 3 shows a more detailed architecture for detecting regressions according to some embodiments of the invention. Within a production environment 302, one or more customer workloads may execute against a production DB product. At (1) one or more customer workloads may be identified and stored within a repository 304. The stored workloads can include those provided by customers, customer workloads captured with customer consent, custom workloads internally created, benchmark workloads, and/or workloads automatically selected for capture by the system.

When a workload is obtained, the system establishes a baseline for the workload to capture expected errors, resource usage, SQL stats, expected errors, etc. These baseline values are stored within a repository 306. Any suitable set of data may be captured to form the baselines. The following are examples of types of baseline data that may be captured: (a) Per workload data, which may include: (i) runtime, (ii) CPU/memory/network io/disk io/etc utilization over the duration of the workload; (b) Per SQL data, which may include: (i) runtime; (ii) CPU time; (iii) buffer gets; (iv) Runtime of individual SQLs; (v) SQL execution result (rows returned or error).

At (2), the stored workloads are executed within a patched cloud environment, and any captured data is compared at (3) to the baseline data from repository 306.

At (4) one or more regression detection clients 308 are used to check for the presence of regressions in the runs. Multiple such Regression Detection Clients 308 are employed, with each client specializing in the detection of a different type of regression. There will be multiple clients able to detect different types of regressions (errors vs wrong results vs performance issues vs etc). Each client will integrate with the Culprit Identification Service (discussed below) by implementing a specific set of APIs that the CIS will call when identifying the culprit transaction.

At (5), the detected regressions are sent to a Culprit Identification Service (CIS). The CIS is used to identify the specific cause of the regression that has been detected. The CIS comprises an API that takes as input information about the regression, returning the culprit ransaction. This is used to support different sources and types of regressions (Regression Detection Clients 308 or “RDC”).

Given a large number of changes that may have been introduced into the patched software, it may not be particularly easy to efficiently determine which change (transaction) is the cause of the regression. The CIS contains various search algorithms to locate the cause of a regression. Given a request to triage a regression from an RDC, the culprit transaction will be identified. In some embodiments, rather than just using a brute force approach, a binary search approach is instead applied by the CIS to identify the culprit transaction 312. At (7), the culprit is identified by the CIS.

At (8) a resolution is applied to address the identified regressions. If the regression is critical, an automated remediation can be applied to roll back the recent changes to restore the application to its previous stable state. Alternatively, a new patch and/or configuration adjustment can be made to resolve the regression without a full rollback. At (9), the patch is delivered to be applied to the software.

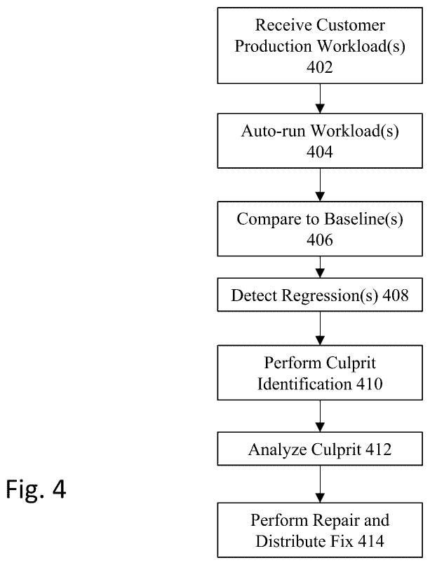

FIG. 4 shows a flowchart of a sequence of steps to be applied in the architecture of FIG. 3. At 402, one or more customer workloads are received. As previously noted, the workloads may be manually provided or automatically acquired by the system. At 404, the workloads may be auto-run with the patched software. The results of the auto-run are compared, at 406, to the baseline data for the production workload.

At 408, one or more regressions may be detected. At 410, culprit identification may be performed by the system to identify the transaction which caused the regression. At 412, the culprit transaction is analyzed to determine a fix for the regression. At 414, a repair is implemented to address the regression.

In some embodiments, to enhance the accuracy of regression detection over time, the system employs machine learning algorithms that analyze past regression data and workload characteristics. By recognizing patterns in historical regressions, the system refines its workload selection, prioritizing test cases likely to uncover new issues. Additionally, feedback from resolved regressions is incorporated into the workload repository, allowing the system to avoid known pitfalls and improve future testing efficiency.

Therefore, what has been described is an improved approach to detect regressions in a cloud-based environment. The system and method offer several key advantages. Improved accuracy and fidelity is provided, since by replaying real customer workloads, the system provides a more accurate assessment of potential regressions compared to synthetic tests, ensuring that the issues detected are highly relevant to actual customer scenarios. The improved approach also allows for comprehensive detection. The system's ability to analyze functional, performance, and infrastructure metrics under varied conditions enables it to detect a wide range of regression types, reducing the risk of undetected issues in production. In addition, scalability and efficiency is provided in the improved approach. The system's architecture is designed for cloud environments, allowing it to scale with the underlying infrastructure. Automated workload capture and replay streamline the testing process, reducing the time and effort required for manual regression analysis. Moreover, the improved approach provides for proactive remediation. Automated remediation capabilities, including rollback and patch application, enable faster recovery from regressions, minimizing customer impact and downtime.

In summary, the invention provides a robust and efficient solution for identifying, analyzing, and resolving regressions in cloud-based applications. By leveraging historical customer workloads, it offers unprecedented accuracy in regression detection, significantly enhancing the reliability and performance of applications deployed in cloud environments.

### System Architecture

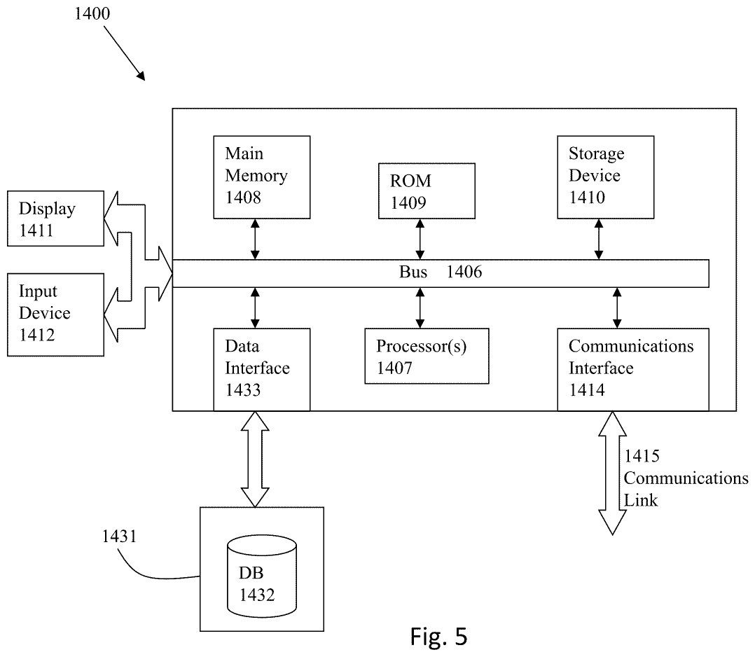

FIG. 5 is a block diagram of an illustrative computing system 1500 suitable for implementing an embodiment of the present invention. Computer system 1500 includes a bus 1506 or other communication mechanism for communicating information, which interconnects subsystems and devices, such as processor 1507, system memory 1508 (e.g., RAM), static storage device 1509 (e.g., ROM), disk drive 1510 (e.g., magnetic or optical), communication interface 1514 (e.g., modem or Ethernet card), display 1511 (e.g., CRT or LCD), input device 1512 (e.g., keyboard), and cursor control.

According to some embodiments of the invention, computer system 1500 performs specific operations by processor 1507 executing one or more sequences of one or more instructions contained in system memory 1508. Such instructions may be read into system memory 1508 from another computer readable/usable medium, such as static storage device 1509 or disk drive 1510. In alternative embodiments, hard-wired circuitry may be used in place of or in combination with software instructions to implement the invention. Thus, embodiments of the invention are not limited to any specific combination of hardware circuitry and/or software. In some embodiments, the term “logic” shall mean any combination of software or hardware that is used to implement all or part of the invention.

The term “computer readable medium” or “computer usable medium” as used herein refers to any medium that participates in providing instructions to processor 1507 for execution. Such a medium may take many forms, including but not limited to, non-volatile media and volatile media. Non-volatile media includes, for example, optical or magnetic disks, such as disk drive 1510. Volatile media includes dynamic memory, such as system memory 1508.

Common forms of computer readable media include, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer can read.

In an embodiment of the invention, execution of the sequences of instructions to practice the invention is performed by a single computer system 1500. According to other embodiments of the invention, two or more computer systems 1500 coupled by communication link 1510 (e.g., LAN, PTSN, or wireless network) may perform the sequence of instructions required to practice the invention in coordination with one another.

Computer system 1500 may transmit and receive messages, data, and instructions, including program, i.e., application code, through communication link 1515 and communication interface 1514. Received program code may be executed by processor 1507 as it is received, and/or stored in disk drive 1510, or other non-volatile storage for later execution. A database 1532 in a storage medium 1531 may be used to store data accessible by the system 1500.

The techniques described may be implemented using various processing systems, such as clustered computing systems, distributed systems, and cloud computing systems. In some embodiments, some or all of the data processing system described above may be part of a cloud computing system. Cloud computing systems may implement cloud computing services, including cloud communication, cloud storage, and cloud processing.

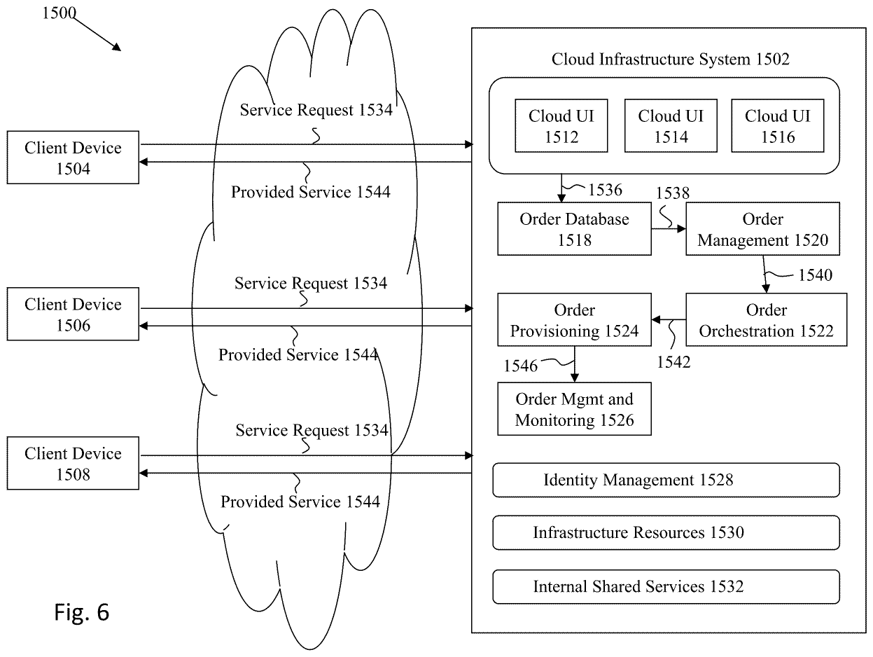

FIG. 6 is a simplified block diagram of one or more components of a system environment 1600 by which services provided by one or more components of an embodiment system may be offered as cloud services, in accordance with an embodiment of the present disclosure. In the illustrated embodiment, system environment 1600 includes one or more client computing devices 1604, 1606, and 1608 that may be used by users to interact with a cloud infrastructure system 1602 that provides cloud services. The client computing devices may be configured to operate a client application such as a web browser, a proprietary client application, or some other application, which may be used by a user of the client computing device to interact with cloud infrastructure system 1602 to use services provided by cloud infrastructure system 1602.

It should be appreciated that cloud infrastructure system 1602 depicted in the figure may have other components than those depicted. Further, the embodiment shown in the figure is only one example of a cloud infrastructure system that may incorporate an embodiment of the invention. In some other embodiments, cloud infrastructure system 1602 may have more or fewer components than shown in the figure, may combine two or more components, or may have a different configuration or arrangement of components. Client computing devices 1604, 1606, and 1608 may be devices similar to those described above for FIG. 6. Although system environment 1600 is shown with three client computing devices, any number of client computing devices may be supported. Other devices such as devices with sensors, etc. may interact with cloud infrastructure system 1602.

Network(s) 1610 may facilitate communications and exchange of data between clients 1604, 1606, and 1608 and cloud infrastructure system 1602. Each network may be any type of network familiar to those skilled in the art that can support data communications using any of a variety of commercially-available protocols. Cloud infrastructure system 1602 may comprise one or more computers and/or servers.

In certain embodiments, services provided by the cloud infrastructure system may include a host of services that are made available to users of the cloud infrastructure system on demand, such as online data storage and backup solutions, Web-based e-mail services, hosted office suites and document collaboration services, database processing, managed technical support services, and the like. Services provided by the cloud infrastructure system can dynamically scale to meet the needs of its users. A specific instantiation of a service provided by cloud infrastructure system is referred to herein as a “service instance.” In general, any service made available to a user via a communication network, such as the Internet, from a cloud service provider's system is referred to as a “cloud service.” Typically, in a public cloud environment, servers and systems that make up the cloud service provider's system are different from the customer's own on-premises servers and systems. For example, a cloud service provider's system may host an application, and a user may, via a communication network such as the Internet, on demand, order and use the application.

In some examples, a service in a computer network cloud infrastructure may include protected computer network access to storage, a hosted database, a hosted web server, a software application, or other service provided by a cloud vendor to a user, or as otherwise known in the art. For example, a service can include password-protected access to remote storage on the cloud through the Internet. As another example, a service can include a web service-based hosted relational database and a script-language middleware engine for private use by a networked developer. As another example, a service can include access to an email software application hosted on a cloud vendor's web site.

In certain embodiments, cloud infrastructure system 1602 may include a suite of applications, middleware, and database service offerings that are delivered to a customer in a self-service, subscription-based, elastically scalable, reliable, highly available, and secure manner.

In various embodiments, cloud infrastructure system 1602 may be adapted to automatically provision, manage and track a customer's subscription to services offered by cloud infrastructure system 1602. Cloud infrastructure system 1602 may provide the cloud services via different deployment models. For example, services may be provided under a public cloud model in which cloud infrastructure system 1602 is owned by an organization selling cloud services and the services are made available to the general public or different industry enterprises. As another example, services may be provided under a private cloud model in which cloud infrastructure system 1602 is operated solely for a single organization and may provide services for one or more entities within the organization. The cloud services may also be provided under a community cloud model in which cloud infrastructure system 1602 and the services provided by cloud infrastructure system 1602 are shared by several organizations in a related community. The cloud services may also be provided under a hybrid cloud model, which is a combination of two or more different models.

In some embodiments, the services provided by cloud infrastructure system 1602 may include one or more services provided under Software as a Service (SaaS) category, Platform as a Service (PaaS) category, Infrastructure as a Service (IaaS) category, or other categories of services including hybrid services. A customer, via a subscription order, may order one or more services provided by cloud infrastructure system 1602. Cloud infrastructure system 1602 then performs processing to provide the services in the customer's subscription order.

In some embodiments, the services provided by cloud infrastructure system 1602 may include, without limitation, application services, platform services and infrastructure services. In some examples, application services may be provided by the cloud infrastructure system via a SaaS platform. The SaaS platform may be configured to provide cloud services that fall under the SaaS category. For example, the SaaS platform may provide capabilities to build and deliver a suite of on-demand applications on an integrated development and deployment platform. The SaaS platform may manage and control the underlying software and infrastructure for providing the SaaS services. By utilizing the services provided by the SaaS platform, customers can utilize applications executing on the cloud infrastructure system. Customers can acquire the application services without the need for customers to purchase separate licenses and support. Various different SaaS services may be provided. Examples include, without limitation, services that provide solutions for sales performance management, enterprise integration, and business flexibility for large organizations.

In some embodiments, platform services may be provided by the cloud infrastructure system via a PaaS platform. The PaaS platform may be configured to provide cloud services that fall under the PaaS category. Examples of platform services may include without limitation services that enable organizations to consolidate existing applications on a shared, common architecture, as well as the ability to build new applications that leverage the shared services provided by the platform. The PaaS platform may manage and control the underlying software and infrastructure for providing the PaaS services. Customers can acquire the PaaS services provided by the cloud infrastructure system without the need for customers to purchase separate licenses and support.

By utilizing the services provided by the PaaS platform, customers can employ programming languages and tools supported by the cloud infrastructure system and also control the deployed services. In some embodiments, platform services provided by the cloud infrastructure system may include database cloud services, middleware cloud services, and Java cloud services. In one embodiment, database cloud services may support shared service deployment models that enable organizations to pool database resources and offer customers a Database as a Service in the form of a database cloud. Middleware cloud services may provide a platform for customers to develop and deploy various business applications, and Java cloud services may provide a platform for customers to deploy Java applications, in the cloud infrastructure system.

Various different infrastructure services may be provided by an IaaS platform in the cloud infrastructure system. The infrastructure services facilitate the management and control of the underlying computing resources, such as storage, networks, and other fundamental computing resources for customers utilizing services provided by the SaaS platform and the PaaS platform.

In certain embodiments, cloud infrastructure system 1602 may also include infrastructure resources 1630 for providing the resources used to provide various services to customers of the cloud infrastructure system. In one embodiment, infrastructure resources 1630 may include pre-integrated and optimized combinations of hardware, such as servers, storage, and networking resources to execute the services provided by the PaaS platform and the SaaS platform.

In some embodiments, resources in cloud infrastructure system 1602 may be shared by multiple users and dynamically re-allocated per demand. Additionally, resources may be allocated to users in different time zones. For example, cloud infrastructure system 1602 may enable a first set of users in a first time zone to utilize resources of the cloud infrastructure system for a specified number of hours and then enable the re-allocation of the same resources to another set of users located in a different time zone, thereby maximizing the utilization of resources.

In certain embodiments, a number of internal shared services 1632 may be provided that are shared by different components or modules of cloud infrastructure system 1602 and by the services provided by cloud infrastructure system 1602. These internal shared services may include, without limitation, a security and identity service, an integration service, an enterprise repository service, an enterprise manager service, a virus scanning and white list service, a high availability, backup and recovery service, service for enabling cloud support, an email service, a notification service, a file transfer service, and the like.

In certain embodiments, cloud infrastructure system 1602 may provide comprehensive management of cloud services (e.g., SaaS, PaaS, and IaaS services) in the cloud infrastructure system. In one embodiment, cloud management functionality may include capabilities for provisioning, managing and tracking a customer's subscription received by cloud infrastructure system 1602, and the like.

In one embodiment, as depicted in the figure, cloud management functionality may be provided by one or more modules, such as an order management module 1620, an order orchestration module 1622, an order provisioning module 1624, an order management and monitoring module 1626, and an identity management module 1628. These modules may include or be provided using one or more computers and/or servers, which may be general purpose computers, specialized server computers, server farms, server clusters, or any other appropriate arrangement and/or combination.

In operation 1634, a customer using a client device, such as client device 1604, 1606 or 1608, may interact with cloud infrastructure system 1602 by requesting one or more services provided by cloud infrastructure system 1602 and placing an order for a subscription for one or more services offered by cloud infrastructure system 1602. In certain embodiments, the customer may access a cloud User Interface (UI), cloud UI 1612, cloud UI 1614 and/or cloud UI 1616 and place a subscription order via these UIs. The order information received by cloud infrastructure system 1602 in response to the customer placing an order may include information identifying the customer and one or more services offered by the cloud infrastructure system 1602 that the customer intends to subscribe to.

After an order has been placed by the customer, the order information is received via the cloud UIs, 1612, 1614 and/or 1616. At operation 1636, the order is stored in order database 1618. Order database 1618 can be one of several databases operated by cloud infrastructure system 1618 and operated in conjunction with other system elements. At operation 1638, the order information is forwarded to an order management module 1620. In some instances, order management module 1620 may be configured to perform billing and accounting functions related to the order, such as verifying the order, and upon verification, booking the order. At operation 1640, information regarding the order is communicated to an order orchestration module 1622. Order orchestration module 1622 may utilize the order information to orchestrate the provisioning of services and resources for the order placed by the customer. In some instances, order orchestration module 1622 may orchestrate the provisioning of resources to support the subscribed services using the services of order provisioning module 1624.

In certain embodiments, order orchestration module 1622 enables the management of business processes associated with each order and applies business logic to determine whether an order should proceed to provisioning. At operation 1642, upon receiving an order for a new subscription, order orchestration module 1622 sends a request to order provisioning module 1624 to allocate resources and configure those resources needed to fulfill the subscription order. Order provisioning module 1624 enables the allocation of resources for the services ordered by the customer. Order provisioning module 1624 provides a level of abstraction between the cloud services provided by cloud infrastructure system 1602 and the physical implementation layer that is used to provision the resources for providing the requested services. Order orchestration module 1622 may thus be isolated from implementation details, such as whether or not services and resources are actually provisioned on the fly or pre-provisioned and only allocated/assigned upon request.

At operation 1644, once the services and resources are provisioned, a notification of the provided service may be sent to customers on client devices 1604, 1606 and/or 1608 by order provisioning module 1624 of cloud infrastructure system 1602.

At operation 1646, the customer's subscription order may be managed and tracked by an order management and monitoring module 1626. In some instances, order management and monitoring module 1626 may be configured to collect usage statistics for the services in the subscription order, such as the amount of storage used, the amount data transferred, the number of users, and the amount of system up time and system down time.

In certain embodiments, cloud infrastructure system 1602 may include an identity management module 1628. Identity management module 1628 may be configured to provide identity services, such as access management and authorization services in cloud infrastructure system 1602. In some embodiments, identity management module 1628 may control information about customers who wish to utilize the services provided by cloud infrastructure system 1602. Such information can include information that authenticates the identities of such customers and information that describes which actions those customers are authorized to perform relative to various system resources (e.g., files, directories, applications, communication ports, memory segments, etc.) Identity management module 1628 may also include the management of descriptive information about each customer and about how and by whom that descriptive information can be accessed and modified.

In the foregoing specification, the invention has been described with reference to specific embodiments thereof. It will, however, be evident that various modifications and changes may be made thereto without departing from the broader spirit and scope of the invention. For example, the above-described process flows are described with reference to a particular ordering of process actions. However, the ordering of many of the described process actions may be changed without affecting the scope or operation of the invention. The specification and drawings are, accordingly, to be regarded in an illustrative rather than restrictive sense.

What is claimed is:

1. A method, comprising:
maintaining a copy of a customer workload in a cloud computing environment along with baseline data for execution of the customer workload;
installing an update to software in an updated cloud computing environment;
running the customer workload in the updated cloud computing environment having the update that was installed, wherein execution data is generated for running the customer workload in the updated cloud computing environment;
comparing the baseline data against the execution data; and
detecting a regression based at least in part on comparison of the baseline data against the execution data.

2. The method of claim 1, wherein a plurality of regression detection clients is used to detect regressions, and each of the plurality of regression detection clients detects for a different regression.

3. The method of claim 1, wherein the baseline data comprises at least one of per-workload data or per-SQL data.

4. The method of claim 1, wherein the customer workload is stored by at least one of a manual selection by a customer or automated selection of the customer workload.

5. The method of claim 4, in which the customer workload is automatically selected by using a database replay function.

6. The method of claim 1, wherein culprit identification is performed to identify a specific change within the update to the software that causes the regression.

7. The method of claim 1, wherein a patch is applied to the software to repair the regression.

8. A computer program product embodied on a computer readable medium, the computer readable medium having stored thereon a sequence of instructions which, when executed by a processor, executes actions comprising:
maintaining a copy of a customer workload in a cloud computing environment along with baseline data for execution of the customer workload;
installing an update to software in an updated cloud computing environment;
running the customer workload in the updated cloud computing environment having the update that was installed, wherein execution data is generated for running the customer workload in the updated cloud computing environment;
comparing the baseline data against the execution data; and
detecting a regression based at least in part on comparison of the baseline data against the execution data.

9. The computer program product of claim 8, wherein a plurality of regression detection clients is used to detect regressions, and each of the plurality of regression detection clients detects for a different regression.

10. The computer program product of claim 8, wherein the baseline data comprises at least one of per-workload data or per-SQL data.

11. The computer program product of claim 8, wherein the customer workload is stored by at least one of a manual selection by a customer or automated selection of the customer workload.

12. The computer program product of claim 11, in which the customer workload is automatically selected by using a database replay function.

13. The computer program product of claim 8, wherein culprit identification is performed to identify a specific change within the update to the software that causes the regression.

14. The computer program product of claim 8, wherein a patch is applied to the software to repair the regression.

15. A system, comprising:
a processor;
a memory for holding programmable code; and
wherein the programmable code includes instructions executable by the processor for maintaining a copy of a customer workload in a cloud computing environment along with baseline data for execution of the customer workload; installing an update to software in an updated cloud computing environment; running the customer workload in the updated cloud computing environment having the update that was installed, wherein execution data is generated for running the customer workload in the updated cloud computing environment; comparing the baseline data against the execution data; and detecting a regression based at least in part on comparison of the baseline data against the execution data.

16. The system of claim 15, wherein a plurality of regression detection clients is used to detect regressions, and each of the plurality of regression detection clients detects for a different regression.

17. The system of claim 15, wherein the baseline data comprises at least one of per-workload data or per-SQL data.

18. The system of claim 15, wherein the customer workload is stored by at least one of a manual selection by a customer or automated selection of the customer workload.

19. The system of claim 18, in which the customer workload is automatically selected by using a database replay function.

20. The system of claim 15, wherein culprit identification is performed to identify a specific change within the update to the software that causes the regression.

21. The system of claim 15, wherein a patch is applied to the software to repair the regression.
